(19) United States
(12) Patent Application Publication
(10) Pub. No.: US 2024/0393796 A1
(43) Pub. Date: Nov. 28, 2024

(54) METHOD AND APPARATUS FOR ADJUSTING LATERAL PARKING ALIGNMENT OF PARKED VEHICLE BY USING RSPA

(71) Applicants: Hyundai Motor Company, Seoul (KR); Kia Corporation, Seoul (KR)

(72) Inventor: Nak Hyun Kim, Anyang-si (KR)

(21) Appl. No.: 18/397,848

(22) Filed: Dec. 27, 2023

(30) Foreign Application Priority Data
May 22, 2023 (KR) 10-2023-0065513

(51) Int. Cl. G05D 1/222; B60Q 1/50

(52) U.S. Cl. CPC G05D 1/222; B60Q 1/547

(57) ABSTRACT

An embodiment parking alignment adjustment apparatus includes one or more processors and a storage device storing a program to be executed by the one or more processors, the program including instructions for receiving a lateral parking alignment adjustment command from a person in possession of a smart key for a host vehicle parked in a specific parking area, detecting a motion of the person and determining an adjustment direction of the host vehicle, and controlling the host vehicle to be moved and parked by a first lateral distance within the specific parking area according to the lateral parking alignment adjustment command and the adjustment direction.

### CROSS-REFERENCE TO RELATED APPLICATIONS

This application claims the benefit of Korean Patent Application Number 10-2023-0065513, filed on May 22, 2023, which application is hereby incorporated herein by reference.

### TECHNICAL FIELD

The present disclosure relates to method and apparatus for adjusting lateral parking alignment of a parked vehicle using remote smart parking assist (RSPA).

### BACKGROUND

The contents described below simply provide background information related to the present embodiments and do not constitute prior art.

FIG. 1 is a diagram illustrating the operation of a conventional RSPA system.

The RSPA is a parking convenience function in a vehicle 100 through which the vehicle 100 recognizes a parking space based on vehicle sensors such as a wide-angle camera 101, an ultrasonic sensor 102, etc., and then the vehicle 100 is automatically steered and controlled to complete parking in the parking space.

As shown in FIG. 1, when the vehicle 100 arrives near a desired parking area 111 while driving in a parking lot including a plurality of parking areas 111 and 112, and a driver of the vehicle 100 operates an RSPA selection button in the vehicle 100, the RSPA function is activated.

After the RSPA function is activated and the driver gets out of the vehicle, when the driver presses a button on a smart key, through the RSPA function, the vehicle 100 can be parked in the desired parking area 111 by automatically steering and controlling the vehicle 100 in the processes of backward \textcircled{1}, forward \textcircled{2}, and backward \textcircled{3}.

In addition, the driver may directly park the vehicle 100 in the desired parking area 111 without using the RSPA function.

However, after the parking of the vehicle 100 in the parking area 111 is completed, when the driver wants to move and park the vehicle 100 to a lateral position at a certain distance to the left or right from the parking area 111, it is unable to park the vehicle 100 by moving it laterally by reflecting the driver's intention through the conventional RSPA function. In addition, when the driver directly drives the vehicle 100 and moves and parks it to a lateral position at a certain distance, a process of directly performing the forward, backward, and steering processes may cause considerable inconvenience to the driver.

### SUMMARY

Embodiments of the present disclosure provide an apparatus for adjusting lateral parking alignment of a parked vehicle using RSPA and an operating method thereof.

The embodiments of the present disclosure are not limited to the aforementioned embodiments, and other embodiments not mentioned above will be clearly understood by a person having ordinary skill in the art through the following description.

At least one embodiment of the present disclosure provides a parking alignment adjustment apparatus including a receiving unit, a determining unit, and a control unit. The receiving unit is configured to receive a lateral parking alignment adjustment command from a driver of a host vehicle parked in a specific parking area. The determining unit is configured to detect a motion of the driver and determine an adjustment direction of the host vehicle. The control unit is configured to control the host vehicle to be moved and parked by a first lateral distance within the specific parking area according to the lateral parking alignment adjustment command and the adjustment direction.

Another embodiment of the present disclosure provides a parking alignment adjustment method including receiving a lateral parking alignment adjustment command from a driver of a host vehicle parked in a specific parking area, determining an adjustment direction of the host vehicle by detecting a motion of the driver, and controlling the host vehicle to be moved and parked by a first lateral distance within the specific parking area according to the lateral parking alignment adjustment command and the adjustment direction.

According to an embodiment of the present disclosure, in a state in which the driver of the vehicle exits the vehicle, it is possible to park the vehicle by moving the vehicle laterally a predetermined distance in a desired direction through simple manipulation of a smart key.

In addition, it is possible to move and park the vehicle in the driver's desired direction and at the driver's designated distance, which facilitates the adjustment of the distance to surrounding vehicles and obstacles and improves the driver's convenience.

The effects of embodiments of the present disclosure are not limited to the effects mentioned above, and other effects not mentioned will be clearly understood by those skilled in the art from the descriptions below.

### BRIEF DESCRIPTION OF THE DRAWINGS

FIG. 1 is a diagram illustrating the operation of a conventional RSPA system.

FIG. 2 is a diagram showing an exemplary functional block diagram for a parking alignment adjustment apparatus according to one embodiment of the present disclosure.

FIG. 3 is a diagram illustrating a situation in which a driver exits a host vehicle after parking the host vehicle in a specific parking area.

FIG. 4 is a diagram illustrating a case where the driver who exited the host vehicle moves in a desired adjustment direction.

FIG. 5 is a diagram illustrating a case in which a plurality of ultrasonic sensors are mounted on a front bumper of the host vehicle.

FIG. 6 is a diagram illustrating a situation in which after the driver moves in the desired adjustment direction, a turn signal lamp corresponding to the adjustment direction blinks.

FIG. 7 is a diagram illustrating a forward operation of the host vehicle when the driver presses a forward button of a smart key.

FIG. 8 is a diagram illustrating a lateral parking operation of the host vehicle when the driver presses a backward button of the smart key after the host vehicle moves forward in the parking area.

FIG. 9 is a flowchart illustrating a method in which the parking alignment adjustment apparatus assists the lateral parking alignment adjustment of the host vehicle according to one embodiment of the present disclosure.

### DETAILED DESCRIPTION OF ILLUSTRATIVE EMBODIMENTS

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject matter of embodiments of the present disclosure will be omitted for the purpose of clarity and for brevity.

Various ordinal numbers or alpha codes such as first, second, i), ii), a), b), etc. are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of embodiments of the present disclosure to be presented below in conjunction with the accompanying drawings is intended to describe exemplary embodiments of the present disclosure and is not intended to represent the only embodiments in which the technical idea of the present disclosure may be practiced.

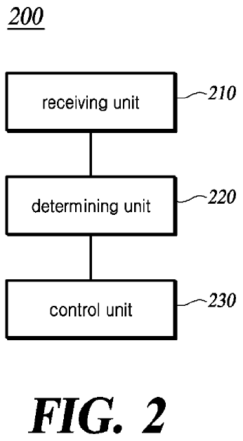

FIG. 2 is a diagram showing an exemplary functional block diagram for a parking alignment adjustment apparatus according to one embodiment of the present disclosure.

As shown in FIG. 2, the parking alignment adjustment apparatus 200 according to one embodiment of the present disclosure includes a receiving unit 210, a determining unit 220, and a control unit 230.

Not all blocks shown in FIG. 2 are essential components, and some blocks included in FIG. 2 may be added, changed, or deleted in other embodiments. Meanwhile, the components shown in FIG. 2 represent functionally distinct elements, and at least one component may be implemented in an integrated form in an actual physical environment.

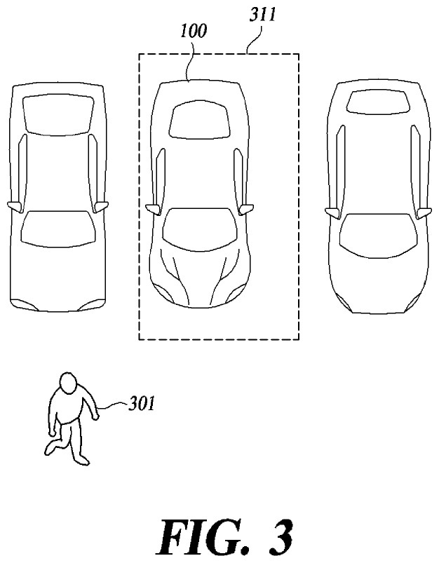

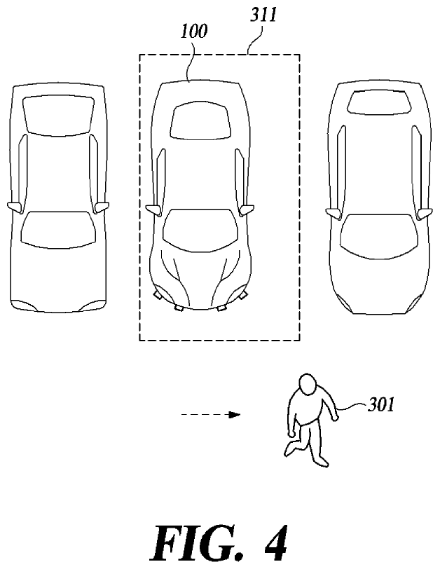

FIG. 3 is a diagram illustrating a situation in which a driver 301 exits a host vehicle 100 after parking the host vehicle 100 in a specific parking area 311, and FIG. 4 is a diagram illustrating a case where the driver 301 who exited the host vehicle 100 moves in a desired adjustment direction.

Hereinafter, the parking alignment adjustment apparatus 200 will be described with reference to FIGS. 2 to 4.

The receiving unit 210 receives a lateral parking alignment adjustment command from the driver 301 of the host vehicle 100 parked in the specific parking area 311 and notifies the determining unit 220 that the lateral parking alignment adjustment command has been received.

As illustrated in FIG. 3, after the driver 301 of the host vehicle 100 parks the host vehicle 100 in the specific parking area 311 and exits the host vehicle 100, the receiving unit 210 receives a lateral parking alignment adjustment command from the driver 301.

In this case, when the driver 301 presses a button corresponding to the lateral parking alignment adjustment command on a smart key carried by the driver 301, the lateral parking alignment adjustment command may be wirelessly transmitted to the receiving unit 210. Here, the smart key is a device carried by the driver 301 for remote parking-related control including transmission of the lateral parking alignment adjustment command for the host vehicle 100, remote forward and backward control for the host vehicle 100, and the like.

The receiving unit 210 may receive a first lateral distance from the driver 301 of the host vehicle 100. The receiving unit 210 provides the driver with a plurality of candidate lateral distance information on a screen using a user interface in the host vehicle 100 such as a user setting mode (USM). When the driver selects one of the plurality of displayed candidate lateral distances, the receiving unit 210 stores information on the selected candidate lateral distance as a first lateral distance.

For example, the receiving unit 210 displays a plurality of candidate lateral distances such as “\textcircled{1} 0.05 m/\textcircled{2} 0.1 m/\textcircled{3} 0.15 m” on the screen of the USM, and when the driver selects one of them (e.g., \textcircled{1} 0.05 m), the receiving unit 210 stores the selected candidate lateral distance as the first lateral distance.

Meanwhile, the first lateral distance may also be determined as a predetermined distance, such as 0.1 m.

The receiving unit 210 may be implemented to receive a lateral parking alignment adjustment command after checking whether the host vehicle 100 is parked at right angles.

The receiving unit 210 may check whether the host vehicle 100 is parked at right angles using a vehicle sensor such as the wide-angle camera 101 and the ultrasonic sensor 102 mounted on the host vehicle 100.

In case it is determined that the host vehicle 100 is parked at right angles, when a lateral parking alignment adjustment command is transmitted from the driver 301, the receiving unit 210 receives the lateral parking alignment adjustment command. However, in case it is determined that the host vehicle 100 is parked in parallel rather than parked at right angles, the receiving unit 210 may be implemented not to receive the lateral parking alignment adjustment command even when it is transmitted from the driver 301, and both turn signal lamps may be implemented to blink for a certain period of time (e.g., 3 seconds) to inform the driver 301 that the transverse movement cannot be performed.

In addition, when the lateral parking alignment adjustment command is transmitted, the receiving unit 210 may also be implemented to receive the lateral parking alignment adjustment command without checking whether or not the host vehicle 100 is parked at right angles and notify the determining unit 220 that the lateral parking alignment adjustment command has been received.

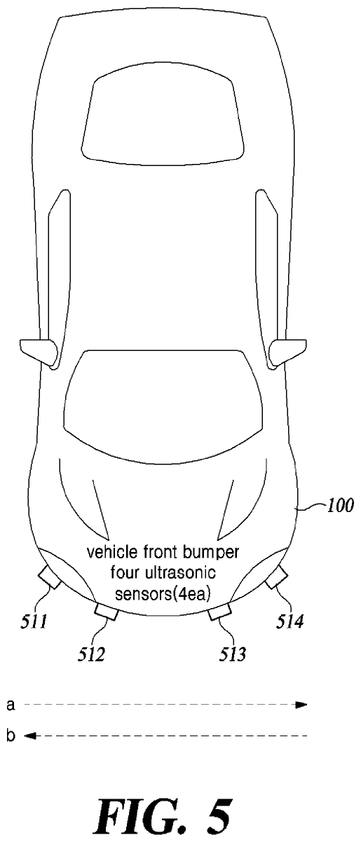

FIG. 5 is a diagram illustrating a case in which a plurality of ultrasonic sensors are mounted on a front bumper of the host vehicle 100.

When the receiving unit 210 notifies the determining unit 220 that the driver's lateral parking alignment adjustment command has been received, the determining unit 220 detects a motion of the driver 301, determines an adjustment direction of the host vehicle 100, and notifies the control unit 230 of information on the determined adjustment direction.

As illustrated in FIG. 4, the determining unit 220 may determine an adjustment direction by detecting a moving direction of the driver 301. The driver 301 may determine the adjustment direction of the host vehicle 100 by moving in his/her desired adjustment direction.

The determining unit 220 may determine an adjustment direction of the host vehicle 100 by detecting whether the driver 301 is moving to the right or left of the host vehicle 100 using a motion sensor.

In this case, various sensors such as ultrasonic sensors 511, 512, 513, and 514 as shown in FIG. 5 may be used as the motion sensor.

The determining unit 220 may detect the driver's moving direction using a plurality of ultrasonic sensors 511, 512, 513, and 514, and the plurality of ultrasonic sensors 511, 512, 513, and 514 are mounted on the front bumper of the host vehicle 100 in a line while being spaced apart from each other in a lateral direction.

When the driver 301 moves in direction a, that is, when the driver 301 moves to the left based on a direction in which the driver is viewed from the host vehicle 100, a first ultrasonic sensor 511, a second ultrasonic sensor 512, a third ultrasonic sensor 513, and a fourth ultrasonic sensor 514 sequentially sense the driver 301. In this case, the determining unit 220 determines the adjustment direction of the host vehicle 100 as the left side of the host vehicle 100.

When the driver 301 moves in direction b, that is, when the driver 301 moves to the right based on the direction in which the driver 301 is viewed from the host vehicle 100, the fourth ultrasonic sensor 514, the third ultrasonic sensor 513, the second ultrasonic sensor 512, and the first ultrasonic sensor 511 sequentially sense the driver 301. In this case, the determining unit 220 determines the adjustment direction of the host vehicle 100 as the right side of the host vehicle 100.

However, some ultrasonic sensors among the plurality of ultrasonic sensors 511, 512, 513, and 514 may not detect the driver 301 depending on the driver's position. Therefore, when at least two ultrasonic sensors among the plurality of ultrasonic sensors 511, 512, 513, and 514 detect the driver 301, the determining unit 220 may determine the adjustment direction of the host vehicle 100 based on the order of the ultrasonic sensors that detected the driver 301.

For example, when the first ultrasonic sensor 511 and the second ultrasonic sensor 512 sequentially detected the driver 301, and the third ultrasonic sensor 513 and the fourth ultrasonic sensor 514 did not detect the driver 301, the determining unit 220 may detect that the driver 301 has moved in the direction a and determine the adjustment direction of the host vehicle 100 as the left side of the host vehicle 100.

The determining unit 220 determines the adjustment direction when a driver's motion is detected within a first preset time (e.g., 5 seconds) after receiving the lateral parking alignment adjustment command. When no driver's motion is detected within the first preset time after the lateral parking alignment adjustment command is received, the determining unit 220 may be implemented not to perform an operation for determining the adjustment direction of the host vehicle 100.

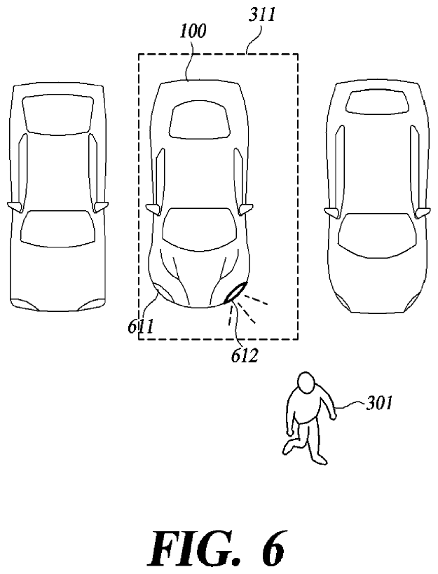

FIG. 6 is a diagram illustrating a situation in which after the driver 301 moves in the desired adjustment direction, a turn signal lamp corresponding to the adjustment direction blinks.

The determining unit 220 is implemented to blink the corresponding turn signal lamp of the host vehicle 100 according to the determined adjustment direction.

As shown in FIG. 6, when the driver 301 exits the host vehicle 100 and moves in the direction a, the determining unit 220 determines the adjustment direction as the direction a and blinks a left turn signal lamp 612 corresponding to the direction a.

In addition, when the driver 301 exits the host vehicle 100 and moves in the direction b, the determining unit 220 determines the adjustment direction as the direction b and blinks a right turn signal lamp 611 corresponding to the direction b.

The right turn signal lamp 611 or the left turn signal lamp 612 may be implemented to continue blinking until the lateral parking alignment adjustment of the host vehicle 100 is completed. In addition, the right turn signal lamp 611 or the left turn signal lamp 612 may be implemented to be automatically turned off when the lateral parking alignment adjustment does not start within a preset second time period (e.g., 10 seconds) after the blinking starts. Moreover, the right turn signal lamp 611 or the left turn signal lamp 612 may also be implemented to automatically turn off when the lateral parking alignment adjustment is not completed within the corresponding preset second time period after the blinking starts.

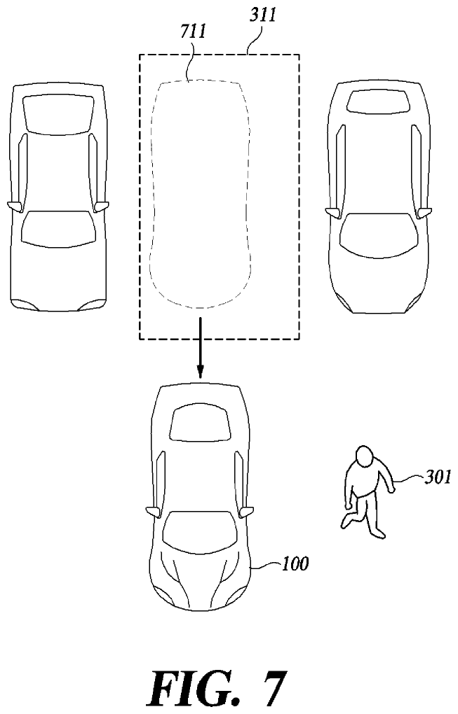

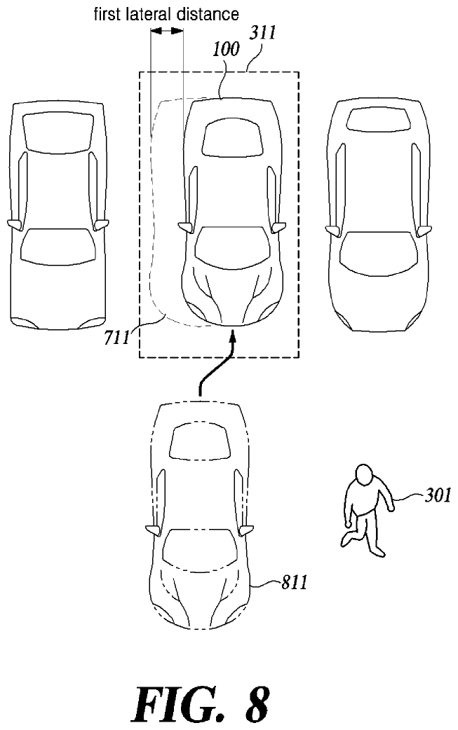

FIG. 7 is a diagram illustrating a forward operation of the host vehicle when the driver presses a forward button of a smart key, and FIG. 8 is a diagram illustrating a lateral parking operation of the host vehicle when the driver presses a backward button of the smart key after the host vehicle moves forward in the parking area.

The control unit 230 controls the host vehicle 100 to be parked at a position moved by a first lateral distance within a specific parking area according to a lateral parking alignment adjustment command and an adjustment direction.

After the determining unit 220 determines the adjustment direction and starts blinking the turn signal lamp corresponding to the determined adjustment direction, the driver 301 presses a button corresponding to a first remote command, that is, a command to move in a first direction (e.g., a forward direction) by using the smart key carried by the driver 301.

In this case, while the driver 301 is pressing the button corresponding to the first direction movement of the smart key, as shown in FIG. 7, the RSPA of the host vehicle 100 controls the host vehicle 100 to move forward. At this time, the RSPA of the host vehicle 100 controls the host vehicle 100 to move forward and stop using a remote start control, steering control device, braking control device, drive control device, shift control device, and the like of the host vehicle 100.

After the host vehicle 100 is moved from an original parking position 711 in the first direction according to the first remote command of the driver 301, the driver presses a button corresponding to a second remote command, that is, a command to move in a second direction (e.g., a backward direction) by using the smart key. In this case, while the driver 301 is pressing the button corresponding to the movement in the second direction of the smart key, the RSPA of the host vehicle 100 controls the host vehicle 100 to move backward along a path shown in FIG. 8.

In this case, the control unit 230 controls the host vehicle 100 to be parked at a position shifted in the adjustment direction by the first lateral distance from the original parking position 711 in the specific parking area 311. At this time, the RSPA of the host vehicle 100 controls the host vehicle 100 to move backward and stop using the remote start control, steering control device, braking control device, drive control device, shift control device, and the like of the host vehicle 100.

When the host vehicle 100 moves in the second direction according to the second remote command, the control unit 230 generates a target trajectory from a first position 811 after the movement of the host vehicle 100 in the first direction is completed to a second position in the specific parking area 311. In this case, the second position means a position moved in the adjustment direction by the first lateral distance from the original parking position 711.

After the target trajectory is generated, the RSPA of the host vehicle 100 controls the host vehicle 100 to move backward along the target trajectory generated by the control unit 230 to be parked in the second position.

In the present embodiment, it is described that the first direction is the forward direction and the second direction is the backward direction, but the embodiments of the present disclosure are not limited thereto. Depending on embodiments, the first direction may be the backward direction and the second direction may be the forward direction.

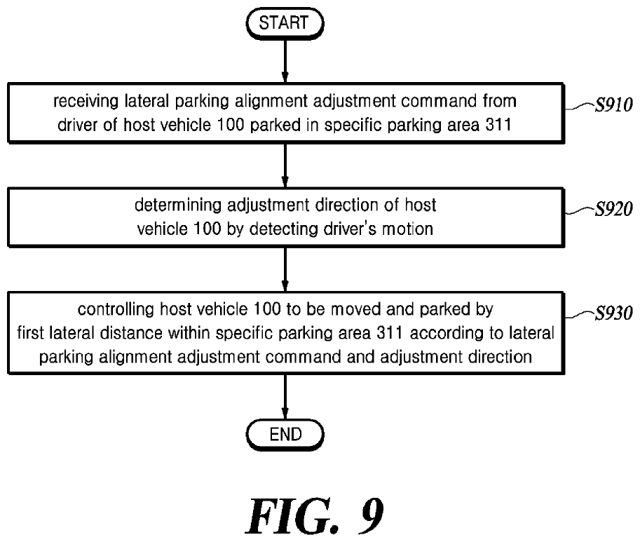

FIG. 9 is a flowchart illustrating a method in which the parking alignment adjustment apparatus 200 assists the lateral parking alignment adjustment of the host vehicle 100 according to one embodiment of the present disclosure.

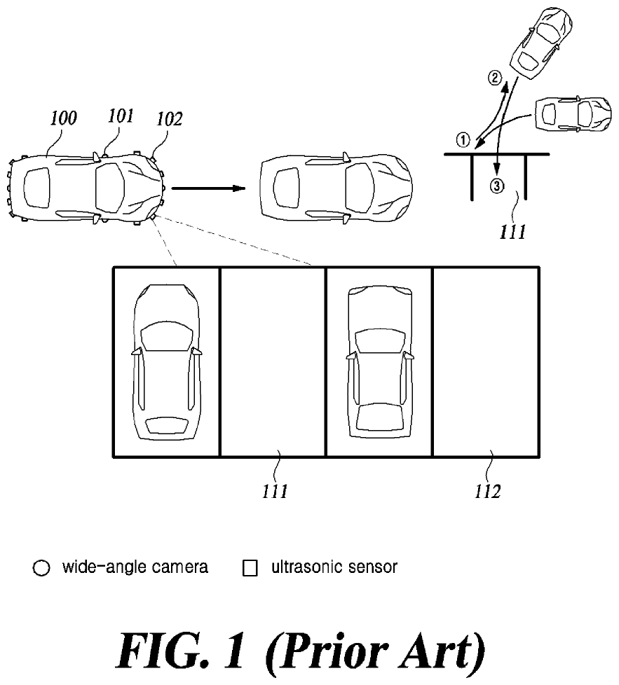

Hereinafter, the parking alignment adjustment method according to the present embodiment will be described with reference to FIGS. 1 to 9 together.

The receiving unit 210 receives a lateral parking alignment adjustment command from the driver of the host vehicle 100 parked in the specific parking area 311 (S910).

The determining unit 220 detects the motion of the driver 301 to determine the adjustment direction of the host vehicle 100 (S920).

The control unit 230 controls the host vehicle 100 to be moved and parked by the first lateral distance within the specific parking area 311 according to the lateral parking alignment adjustment command and the adjustment direction (S930).

Since the operations of the receiving unit 210, the determining unit 220, and the control unit 230 have been described above, a detailed description thereof will be omitted.

Each component of the device or method according to embodiments of the present disclosure may be implemented in hardware, software, or a combination of the hardware and software. In addition, the function of each component may be implemented as software, and a microprocessor may be implemented to execute the software function corresponding to each component.

Various implementations of the systems and techniques described herein may include digital electronic circuits, integrated circuits, field programmable gate arrays (FPGAs), application specific integrated circuits (ASICs), computer hardware, firmware, software, and/or a combination thereof. These various implementations may include implementations with one or more computer programs executable on a programmable system. The programmable system includes at least one programmable processor (which may be a special purpose processor or a general purpose processor) combined to receive and transmit data and instructions from and to a storage system, at least one input device, and at least one output device. The computer programs (also known as programs, software, software applications, or codes) include instructions for a programmable processor and are stored in a “computer-readable storage medium.”

The computer-readable storage medium includes all kinds of storage devices that store data readable by a computer system. The computer-readable storage medium may include a non-volatile or non-transitory medium such as a ROM, CD-ROM, magnetic tape, floppy disk, memory card, hard disk, magneto-optical disk, and storage device, and also further include a transitory medium such as a data transmission medium. Moreover, the computer-readable storage medium may be distributed in computer systems connected through a network, and computer-readable codes may be stored and executed in a distributed manner.

In the flowcharts in the present specification, it is described that each process sequentially occurs, but this is merely an example of the technology of an embodiment of the present disclosure. In other words, a person having ordinary skill in the art to which an embodiment of the present disclosure pertains may make various modifications and variations by changing the orders described in the flowcharts in the present specification or by undergoing one or more of the processes in parallel within the essential characteristics of an embodiment of the present disclosure, so the flowcharts in this specification are not limited to a time-series order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

The following reference identifiers may be used in connection with the figures to describe various features of embodiments of the present disclosure.
100: host vehicle
101: wide-angle camera
102: ultrasonic sensor
111: parking area
200: parking alignment adjustment apparatus
210: receiving unit
220: determining unit
230: control unit
301: driver
311: specific parking area
511, 512, 513, 514: ultrasonic sensor
611: right turn signal lamp
612: left turn signal lamp
711: original parking position
811: first position

What is claimed is:

1. A parking alignment adjustment apparatus, the apparatus comprising:
one or more processors; and
a storage device storing a program to be executed by the one or more processors, the program including instructions for:
receiving a lateral parking alignment adjustment command from a person in possession of a smart key for a host vehicle parked in a specific parking area;
detecting a motion of the person and determining an adjustment direction of the host vehicle; and
controlling the host vehicle to be moved and parked by a first lateral distance within the specific parking area according to the lateral parking alignment adjustment command and the adjustment direction.

2. The apparatus of claim 1, wherein the program further includes instructions for receiving the first lateral distance from the person.

3. The apparatus of claim 2, wherein the program further includes instructions for receiving one candidate lateral distance selected by the person among a plurality of candidate lateral distances selectable by the person and determining the one candidate lateral distance as the first lateral distance.

4. The apparatus of claim 1, wherein the program further includes instructions for receiving the lateral parking alignment adjustment command after checking whether the host vehicle is parked at right angles.

5. The apparatus of claim 1, wherein the program further includes instructions for determining the adjustment direction by detecting a moving direction of the person.

6. The apparatus of claim 5, wherein the program further includes instructions for detecting the moving direction of the person using a plurality of motion sensors mounted on a front side of the host vehicle.

7. The apparatus of claim 6, wherein the plurality of motion sensors are arranged spaced apart from each other in a lateral direction.

8. The apparatus of claim 7, wherein the program further includes instructions for detecting the moving direction according to an order in which at least two motion sensors among the plurality of motion sensors detect the person.

9. The apparatus of claim 1, wherein the program further includes instructions for blinking a turn signal lamp of the host vehicle corresponding to the adjustment direction.

10. The apparatus of claim 1, wherein the program further includes instructions for determining the adjustment direction in response to the motion of the person being detected within a predetermined time after receiving the lateral parking alignment adjustment command.

11. The apparatus of claim 1, wherein the program further includes instructions for controlling the host vehicle to be parked at a position moved by the first lateral distance from an original parking position of the host vehicle in the adjustment direction in response to the host vehicle being moved in a first direction according to a first remote command of the person and then being moved in a second direction according to a second remote command of the person.

12. The apparatus of claim 11, wherein the program further includes instructions for generating a target trajectory from a position after movement of the host vehicle in the first direction is completed to the position moved by the first lateral distance from the original parking position of the host vehicle in the adjustment direction.

13. A parking alignment adjustment method, the method comprising:
receiving a lateral parking alignment adjustment command from a person in possession of a smart key for a host vehicle parked in a specific parking area;
determining an adjustment direction of the host vehicle by detecting a motion of the person; and
controlling the host vehicle to be moved and parked by a first lateral distance within the specific parking area according to the lateral parking alignment adjustment command and the adjustment direction.

14. The method of claim 13, wherein receiving the lateral parking alignment adjustment command comprises receiving the first lateral distance from the person.

15. The method of claim 14, wherein receiving the lateral parking alignment adjustment command comprises receiving one candidate lateral distance selected by the person among a plurality of candidate lateral distances selectable by the person and determining the one candidate lateral distance as the first lateral distance.

16. The method of claim 13, wherein determining the adjustment direction of the host vehicle comprises determining the adjustment direction by detecting a moving direction of the person.

17. The method of claim 16, wherein determining the adjustment direction of the host vehicle comprises detecting the moving direction according to an order in which at least two motion sensors among a plurality of motion sensors detect the person.

18. The method of claim 13, wherein determining the adjustment direction of the host vehicle comprises blinking a turn signal lamp of the host vehicle corresponding to the adjustment direction.

19. The method of claim 13, wherein controlling the host vehicle comprises controlling the host vehicle to be parked at a position moved by the first lateral distance from an original parking position of the host vehicle in the adjustment direction in response to the host vehicle being moved in a first direction according to a first remote command of the person and then being moved in a second direction according to a second remote command of the person.

20. The method of claim 19, wherein controlling the host vehicle comprises generating a target trajectory from a position after movement of the host vehicle in the first direction is completed to the position moved by the first lateral distance from the original parking position of the host vehicle in the adjustment direction.
